(19) United States
(12) Patent Application Publication
(10) Pub. No.: US 2025/0051201 A1
(43) Pub. Date: Feb. 13, 2025

(54) WASTEWATER OXIDATION WITH HYDROGEN PEROXIDE INJECTED IN THE AIR-GAP OF A VESSEL

(71) Applicant: Dow Global Technologies LLC, Midland, MI (US)

(72) Inventors: Wu Chen, Freeport, TX (US); Lin Zhao, Freeport, TX (US); Jen-Hsiang Kao, Freeport, TX (US); Michael E. Uhl, Freeport, TX (US)

(73) Assignee: Dow Global Technologies LLC, Midland, MI (US)

(21) Appl. No.: 18/710,765

(22) PCT Filed: Nov. 17, 2022
(86) PCT No.: PCT/US2022/080033

§ 371 Date: May 16, 2024

Related U.S. Application Data
(60) Provisional application No. 63/280,842, filed on Nov. 18, 2021.

(51) Int. Cl. C02F 1/72; C02F 103/34

(52) U.S. Cl. CPC C02F 1/722; C02F 2103/34; C02F 2201/005; C02F 2305/023

(57) ABSTRACT

A system for the treatment of oxidizable contaminants in wastewater includes a contaminant treatment vessel and a hydrogen peroxide supply unit. The hydrogen peroxide supply unit includes a hydrogen peroxide transfer line in fluid communication with the contaminant treatment vessel with an air-gap. A wastewater feed stream may also be in fluid communication with the contaminant treatment vessel. A contaminant treatment vessel effluent stream may also be in fluid communication with the contaminant treatment vessel. A method for the treatment of oxidizable contaminants in wastewater includes supplying wastewater to a contaminant treatment vessel, supplying hydrogen peroxide to the contaminant treatment vessel so that the supply is above the maximum filling level of the vessel in an air-gap, and contacting wastewater in the contaminant treatment vessel with hydrogen peroxide. Contacting wastewater with hydrogen peroxide reduces the concentration of oxidizable contaminants based on the concentration of oxidizable contaminants in the wastewater feed stream.

### CROSS-REFERENCE TO RELATED APPLICATIONS

This application claims the benefit of U.S. Provisional Application Ser. No. 63/280,842 filed Nov. 18, 2021, the entire disclosure of which is hereby incorporated herein by reference.

### TECHNICAL FIELD

The present specification generally relates to systems and processes for treating a stream, and in particular, systems and processes for removing oxidizable contaminants from a liquid medium.

### BACKGROUND

In a number of industrial processes, such as hydrocarbon processes, wastewater streams may be produced. These wastewater streams may be alkaline wastewater streams containing various oxidizable contaminants, such as sulfides. Without treatment, these oxidizable contaminants may leave the facility where the industrial processes occurred. However, environmental concerns have developed with the presence of oxidizable contaminants in these wastewater streams. Typically, these oxidizable contaminants are removed by complicated, multi-step processes, such as precipitation processes. As the presence of oxidizable contaminants is undesirable, an ongoing need exists for systems and processes that may efficiently and effectively reduce the presence of oxidizable contaminants in wastewater streams.

### SUMMARY

Embodiments of the present disclosure are directed to systems and methods of reducing oxidizable contaminants that address this need.

According to one embodiment, a system for the treatment of oxidizable contaminants in wastewater may include a contaminant treatment vessel and a hydrogen peroxide supply unit. The hydrogen peroxide supply unit may include a hydrogen peroxide transfer line in fluid communication with the contaminant treatment vessel, a wastewater feed stream in fluid communication with the contaminant treatment vessel, and a contaminant treatment vessel effluent stream in fluid communication with the contaminant treatment vessel. The hydrogen peroxide transfer line may include one or more hydrogen peroxide pumps, one or more ball valves, and one or more check valves. The hydrogen peroxide transfer line may be in fluid communication with the contaminant treatment vessel at a hydrogen peroxide injection point. The hydrogen peroxide injection point may be positioned above a maximum wastewater fill level of the contaminant treatment vessel such that an air gap exists between the wastewater in the contaminant treatment unit and the hydrogen peroxide injection point. The contaminant treatment vessel effluent stream may comprise less than 0.1 mg/l of oxidizable contaminants regardless of an initial concentration of oxidizable contaminants in the wastewater feed stream.

According to another embodiment, a method for the treatment of oxidizable contaminants in wastewater may include supplying wastewater to a contaminant treatment vessel, supplying hydrogen peroxide to the contaminant treatment vessel, and contacting wastewater in the contaminant treatment vessel with hydrogen peroxide. The hydrogen peroxide may be supplied to the contaminant treatment vessel above a maximum wastewater fill line of the contaminant treatment vessel. Contacting the wastewater with hydrogen peroxide reduces the concentration of oxidizable contaminants based on the concentration of oxidizable contaminants in the wastewater feed stream.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 schematically depicts a generalized flow diagram of a system for removing oxidizable contaminants from wastewater, according to one or more embodiments shown and described in this disclosure;

FIG. 2 schematically depicts a detailed view the interior of a contaminant treatment vessel according to one or more embodiments shown and described in this disclosure;

FIG. 3A is an image of a filter paper for a wastewater sample without hydrogen peroxide treatment; and

FIG. 3B is an image of a filter paper for a wastewater sample after hydrogen peroxide treatment.

### DETAILED DESCRIPTION

The present disclosure is directed to methods for treating oxidizable contaminants in wastewater. In particular, the present disclosure is directed to methods for treating oxidizable contaminants in wastewater comprising supplying wastewater to a contaminant treatment vessel, supplying hydrogen peroxide to the contaminant treatment vessel, and contacting wastewater in the contaminant treatment vessel with the hydrogen peroxide, wherein contacting wastewater with the hydrogen peroxide reduces the concentration of oxidizable contaminants in the wastewater. The present disclosure is also directed to contaminant treatment systems for the treatment of oxidizable contaminants in wastewater. In particular, the systems may comprise a contaminant treatment vessel and a hydrogen peroxide supply unit.

The various oxidizable contaminant treatment systems and methods of the present disclosure for the treatment of oxidizable contaminants in wastewater may provide increased efficiency in the treatment of oxidizable contaminants compared to conventional systems and methods for the treatment of oxidizable contaminants in wastewater. That is, the various contaminant treatment systems and methods may efficiently and effectively reduce the presence of oxidizable contaminants in wastewater without the need for a complicated, multi-step process.

Contacting hydrogen peroxide with wastewater comprising undesirable oxidizable contaminants may efficiently and effectively treat oxidizable contaminants in the wastewater, but the combination of wastewater and hydrogen peroxide may be hazardous. Accordingly, the embodiments disclosed and described herein provide systems and processes where hydrogen peroxide may be combined with wastewater while minimizing any risk of undesirable combination of wastewater and hydrogen peroxide. As further described below, the combination of hydrogen peroxide with wastewater containing oxidizable contaminants may result in an exothermic reaction. Therefore, it may be important to control the combination of wastewater and hydrogen peroxide.

Reference will now be made in detail to embodiments of systems and methods for reducing oxidizable contaminants in wastewater.

Although the concepts of the present disclosure are described herein with primary reference to reducing oxidizable contaminants in wastewater streams, it is contemplated that the concepts will be applicable to other oxidizable contaminants in other liquid feeds. For example, and not by way of limitation, it is contemplated that the concepts of the present disclosure will enjoy applicability to open water streams containing oxidizable contaminants.

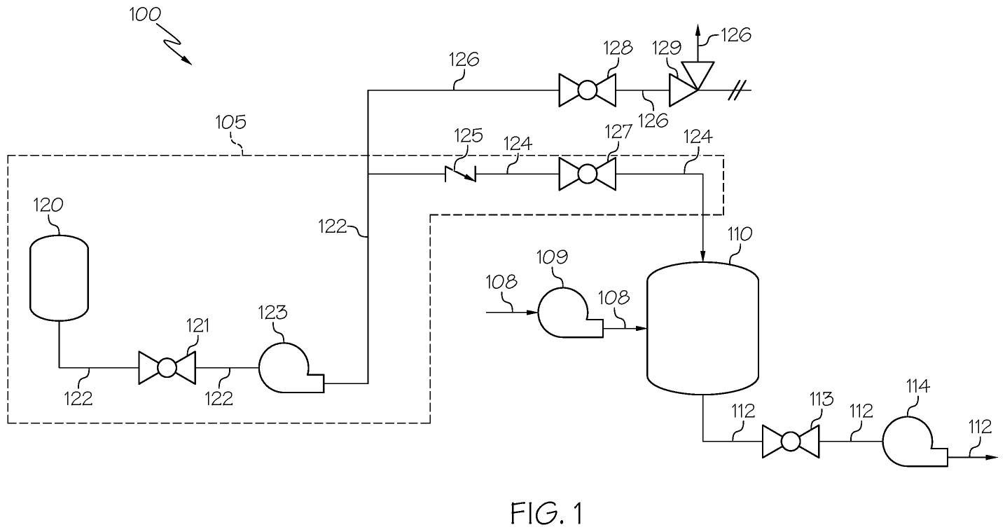

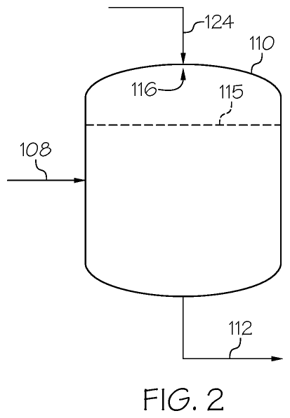

Referring initially to FIGS. 1 and 2, a system 100 for the treatment of oxidizable contaminants in wastewater may comprise a contaminant treatment vessel 110 and a hydrogen peroxide supply unit. The hydrogen peroxide supply unit may comprise a hydrogen peroxide transfer line 124 in fluid communication with the contaminant treatment vessel 110. The hydrogen peroxide transfer lines 122, 124, may comprise one or more hydrogen peroxide pumps 123, one or more ball valves 121, 127, 128, and one or more check valves 125. The hydrogen peroxide transfer line 124 may be in fluid communication with the contaminant treatment vessel 110 at a hydrogen peroxide injection point 116. The hydrogen peroxide injection point 116 may be positioned above a maximum wastewater fill level 115 of the contaminant treatment vessel 110 such that an air gap exists between the wastewater in the contaminant treatment vessel 110 and the hydrogen peroxide injection point 116. The air gap may ensure that wastewater does not flow back into the hydrogen peroxide storage vessel 120. A wastewater feed stream 108 may be in fluid communication with the contaminant treatment vessel 110. A contaminant treatment vessel effluent stream 112 may be in fluid communication with the contaminant treatment vessel 110.

The wastewater may contain various oxidizable contaminants. As used herein, it is noted that “oxidizable contaminant” or “oxidizable contaminants” is utilized to represent both small compounds and minute, separate particles suspended in a liquid medium that may be oxidized when contacted with hydrogen peroxide. The oxidizable contaminants may comprise, consist of, or consist essentially of sulfides, nitrites, phosphites, or combinations of these. In embodiments, the oxidizable contaminants may be capable of undergoing a chemical reaction with oxygen. Sulfide, nitrite, phosphite, or a combination of these compounds may be present in the wastewater in an amount greater than 0.1 mg/l based on the volume of the wastewater, such as an amount greater than 0.5 mg/l, greater than 1.0 mg/l, greater than 2.0 mg/l, or greater than 5.0 mg/l.

Wastewater may be any water that has been contaminated by human use. The wastewater may be a by-product of industrial activities. The wastewater may comprise a pH greater than 7. The wastewater may comprise a pH greater than 14. Alternatively, the wastewater may comprise a pH less than 14. The wastewater may be an alkaline wastewater. That is, the wastewater may comprise a pH greater than 7. Alternatively, the wastewater may be a high alkaline wastewater. As used throughout the present disclosure a “high alkaline wastewater” may refer to an alkaline wastewater comprising a pH greater than 10. In embodiments, the wastewater may comprise a pH of approximately 10.5. The wastewater may be referred to as caustic. That is, the wastewater may be corrosive.

The contaminant treatment vessel 110 may be downstream of the hydrogen peroxide supply unit 105. The contaminant treatment vessel 110 may be any vessel or other like apparatus suitable for mixing two or more streams. The contaminant treatment vessel 110 may include a mixer, such as an agitator. The contaminant treatment vessel 110 may include one or a plurality of vessels. If the contaminant treatment vessel 110 includes a plurality of vessels, the vessels may be in series or in parallel. The contaminant treatment vessel 110 may be operable to contact the wastewater feed stream 108 with hydrogen peroxide in the hydrogen peroxide transfer line 124 to form a contaminant treatment vessel effluent stream 112.

The contaminant treatment vessel 110 may be operable to contact the wastewater feed stream 108 with hydrogen peroxide from the hydrogen peroxide transfer line 124. By contacting the wastewater feed stream 108 with hydrogen peroxide discharged from the hydrogen peroxide transfer line 124, oxidizable contaminants in the wastewater feed stream 108 may be treated. In the contaminant treatment vessel 110, the hydrogen peroxide discharged from the hydrogen peroxide transfer line 124 may interact with the oxidizable contaminants in the wastewater feed stream 108. The hydrogen peroxide discharged from the hydrogen peroxide transfer line 124 may oxidize the oxidizable contaminants in the wastewater feed stream 108. When the oxidizable contaminants include sulfides, nitrites, phosphites, or combinations of these, the hydrogen peroxide discharged from the hydrogen peroxide transfer line 124 may oxidize the oxidizable contaminants to sulfates, nitrates, phosphates, or combinations of these, respectively. The oxidized forms of above contaminants are non-hazardous and considered safe to be in the contaminant treatment vessel effluent 112. If the above contaminants are not oxidized before discharging, they may reduce the dissolved oxygen levels in the water over time and may endanger aquatic life forms.

The contaminant treatment vessel 110 may operate at a temperature of less than 70 degrees Celsius (° C.). For example, the contaminant treatment vessel 110 may operate at a temperature of less than 60° C. or less than 50° C. In embodiments, the contaminant treatment vessel 110 may operate at a temperature from greater than 20° C. to less than 50° C., such as from 30° C. to less than 50° C. or from 40° C. to less than 50° C. Contacting the hydrogen peroxide with wastewater at temperatures in excess of 70° C. may result in the hydrogen peroxide degrading more quickly than desired and not effectively and efficiently treating oxidizable contaminants in the wastewater.

Still referring to FIG. 1, the system 100 may include the hydrogen peroxide supply unit 105. The hydrogen peroxide supply unit 105 may be disposed upstream of the contaminant treatment vessel 110. The hydrogen peroxide supply unit 105 may include a hydrogen peroxide transfer line 122, 124 in fluid communication with the contaminant treatment vessel 110. The hydrogen peroxide supply unit 105 may further include a hydrogen peroxide storage vessel 120.

The hydrogen peroxide storage vessel 120 may be disposed upstream of the hydrogen peroxide transfer line 122, 124. The hydrogen peroxide storage vessel 120 may be any unit operable to store a quantity of hydrogen peroxide to eventually be supplied to the contaminant treatment vessel 110 on an as-needed basis. While it is contemplated that the hydrogen peroxide storage vessel 120 may store pure hydrogen peroxide, the hydrogen peroxide in the hydrogen peroxide storage vessel 120 may be a dilute hydrogen peroxide solution. In embodiments, the hydrogen peroxide may be 20% hydrogen peroxide, 25% hydrogen peroxide, 30% hydrogen peroxide, 35% hydrogen peroxide, 40% hydrogen peroxide, 45% hydrogen peroxide, or 50% hydrogen peroxide. The hydrogen peroxide may be diluted in water. As will be appreciated by one skilled in the art, in 20% hydrogen peroxide, for example, 20% of the solution may be hydrogen peroxide and 80% of the solution may be water.

The hydrogen peroxide transfer line 122, 124 the hydrogen peroxide storage vessel 120 and the contaminant treatment vessel 110. The hydrogen peroxide transfer line 122, 124 may include various valves and pumps operable to regulate the amount of hydrogen peroxide supplied to the contaminant treatment vessel 110.

Still referring to FIG. 1, the system 100 may comprise a plurality of valves. The valves may be operable to control the flow of wastewater and hydrogen peroxide being passed to the contaminant treatment vessel 110 as well as the contaminant treatment vessel effluent 112 being passed out of the contaminant treatment vessel 110. The system 100 may comprise one or more ball valves, one or more check valves, one or more pressure relief valves, or combinations of these. It will be appreciated by those skilled in the art the presence and position of these various valves may not necessarily need to be the same as that depicted in FIG. 1.

The various different types of valves will now be described in greater detail. A ball valve may refer to a valve having a hollow, perforated, and pivoting ball to control flow through it. It is open when the ball's hole is in line with the flow and closed when it is pivoted 90-degrees by the valve handle. In embodiments, a ball valve may be a vented ball valve.

A check valve is a valve that allows a fluid to flow in only one direction. A check valve may be a two port valve, with one port allowing fluid to enter and the other port allowing fluid to leave. A check valve may also be referred to as a clack valve, non-return valve, reflux valve, retention valve, or a one-way valve. A pressure relief valve is a safety valve used to control or limit pressure in a system. A pressure relief valve is designed or set to open at a predetermined set pressure to protect pressure vessels and other equipment from being subjected to pressures that exceed their design limits.

In addition to the various valves, the system 100 may comprise a plurality of pumps. The pumps, together with the valves, may be operable to control the flow of wastewater and hydrogen peroxide being passed to the contaminant treatment vessel 110 as well as the contaminant treatment vessel effluent 112 being passed out of the contaminant treatment vessel 110. The pumps of the system 100 may comprise air diaphragm pumps. An air diaphragm pump may refer to a positive displacement pump that uses a combination of the reciprocating action of a rubber, thermoplastic or teflon diaphragm and suitable valves on either side of the diaphragm to pump a fluid.

The hydrogen peroxide supply unit 105 and its various valves and pumps contemplated in the embodiment disclosed herein will now be described in further detail. As previously described, hydrogen peroxide may be stored in a hydrogen peroxide storage vessel 120. When hydrogen peroxide is supplied to the contaminant treatment vessel 110, it may be passed through the hydrogen peroxide transfer lines 122, 124. The hydrogen peroxide may first be passed through a valve, such as a vented ball valve. The vent of ball valve 121 may vent toward the hydrogen peroxide storage vessel 120.

After passing out of the ball valve 121, the hydrogen peroxide may continue to be passed through the hydrogen peroxide transfer line 122 to the hydrogen peroxide pump 123. In embodiments, the hydrogen peroxide pump 123 may be an air diaphragm pump. After passing out of the hydrogen peroxide pump 123, the hydrogen peroxide may continue to be passed through the hydrogen peroxide transfer line 122. At least a portion of the hydrogen peroxide may then be passed along the hydrogen peroxide transfer line 124 to the contaminant treatment vessel 110. Prior to entering the contaminant treatment vessel 110, the hydrogen peroxide may pass through a check valve 125 and another ball valve 127. Again, in embodiments, this ball valve 127 may be a vented ball valve. The vent of ball valve 127 may vent toward the check valve 125. After passing the ball valve 127, the hydrogen peroxide may continue to be passed through the hydrogen peroxide transfer line 124 to the contaminant treatment vessel 110.

The hydrogen peroxide supply unit 105 may further include a hydrogen peroxide emergency pressure release line 126. It may be undesirable for there to be too much pressure in the hydrogen peroxide supply unit 105. Thus, the hydrogen peroxide emergency release line 126 may direct excess hydrogen peroxide from the hydrogen peroxide transfer line 124 out of the system 100. In the hydrogen peroxide emergency pressure release line 126, a portion of the hydrogen peroxide may be bled or purged from the system 100. A portion of the hydrogen peroxide in the hydrogen peroxide transfer line 122 may be passed through a hydrogen peroxide emergency pressure release line 126. The hydrogen peroxide emergency peroxide release line 126 may include a valve, such as a ball valve 128, which may always be open during operation. The vent of ball valve 128 may vent toward the hydrogen peroxide pump 123. After passing the ball valve 128, the hydrogen peroxide in the hydrogen peroxide emergency pressure relief line 126 may be passed to a pressure relief valve 129. The pressure relief valve 129 may be used to allow the bleeding or purging of hydrogen peroxide in the event excess pressure is generated by hydrogen peroxide from the hydrogen peroxide storage vessel 120 to the hydrogen peroxide transfer line 122, such that the excess pressure and hydrogen peroxide may not be fed to the contaminant treatment vessel 110 via the hydrogen peroxide transfer line 124.

It may be undesirable for excess hydrogen peroxide to be fed to the contaminant treatment vessel 110. If excess hydrogen peroxide were allowed to be fed to the contaminant treatment vessel 110, no additional benefit may be recognized and hydrogen peroxide may be wasted. The one or more hydrogen peroxide pumps 123, in conjunction with the various valves as described above, may be operable to precisely provide the proper amount of hydrogen peroxide to the contaminant treatment vessel 110 such that no excess hydrogen peroxide is fed to the contaminant treatment vessel 110.

Further, it may be undesirable for any wastewater in the contaminant treatment vessel 110 to flow back to the hydrogen peroxide supply unit 105. If the wastewater were allowed to backflow to the hydrogen peroxide supply unit 105, a runaway reaction may occur. As the reaction between the wastewater and hydrogen peroxide may be highly exothermic, the backflow of wastewater to the hydrogen peroxide supply unit 105 may result in a highly exothermic reaction with large pressure build up in the hydrogen peroxide supply unit 105. The various valves (ball valves, check valves, pressure relief valves, or combinations of these) provided in the hydrogen supply unit 105 may reduce or eliminate the possibility of any wastewater backflow into the hydrogen peroxide supply unit 105, and more specifically into the hydrogen peroxide storage vessel 120. In the event that additional pressure builds up in the hydrogen peroxide supply unit 105, the additional pressure may be released through the pressure relief valve 129.

Still referring to FIG. 1, the wastewater feed stream 108 may be pumped by a wastewater feed pump 109. After passing the wastewater feed pump 109, the wastewater feed stream 108 may be supplied to the contaminant treatment vessel 110.

Now referring to FIG. 2, hydrogen peroxide in the hydrogen peroxide supply unit 105 may be supplied to the contaminant treatment vessel 110 via the hydrogen peroxide transfer line 124 at a hydrogen peroxide injection point 116.

The contaminant treatment vessel 110 may comprise a maximum wastewater fill level 115. The maximum wastewater fill level 115 may refer to the maximum height of the wastewater in the contaminant treatment vessel 110. As described herein, it may be important for there to be a sufficient air gap between the maximum wastewater fill level 115 of contaminant treatment vessel 110 and the hydrogen peroxide injection point 116. The air gap may be at least half a meter, one meter, such as at least two meters, at least three meters, at least four meters, or at least five meters.

Referring again to FIG. 1, the system 100 may comprise a contaminant treatment vessel effluent stream 112 in fluid communication with the contaminant treatment vessel 110. The contaminant treatment vessel effluent stream 112 may comprise less oxidizable contaminants than the wastewater feed stream 108. The contaminant treatment vessel effluent stream 112 may comprise less than 0.1 mg/l of oxidizable contaminants regardless of the initial weight percent of oxidizable contaminants in the wastewater feed stream 108. For example, the contaminant treatment vessel effluent stream 112 may comprise less than 0.09 mg/l of oxidizable contaminants, such as less than 0.08 mg/l of oxidizable contaminants, less than 0.07 mg/l of oxidizable contaminants, less than 0.06 mg/l of oxidizable contaminants, less than 0.05 mg/l of oxidizable contaminants, less than 0.04 mg/l of oxidizable contaminants, or less than 0.03 mg/l of oxidizable contaminants regardless of the initial weight percent of oxidizable contaminants in the wastewater feed stream 108.

Referring now to FIGS. 1 and 2, the equipment that may be in contact with hydrogen peroxide (e.g., the hydrogen peroxide supply unit 105, the contaminant treatment vessel 110, or both) may be constructed from materials resistant to the corrosiveness of hydrogen peroxide. In embodiments, the equipment that may be in contact with hydrogen peroxide may be pickled, passivated, or both.

Again referring to FIGS. 1 and 2, methods for the treatment of oxidizable contaminants in wastewater may include supplying wastewater to the contaminant treatment vessel 110, supplying hydrogen peroxide to the contaminant treatment vessel 110, and contacting wastewater in the contaminant treatment vessel 110 with hydrogen peroxide. The hydrogen peroxide may be supplied to the contaminant treatment vessel 110 above the maximum wastewater fill line 115 of the contaminant treatment vessel 110. Contacting wastewater with hydrogen peroxide may reduce the concentration of oxidizable contaminants based on the concentration of oxidizable contaminants in the wastewater feed stream 108. The contaminant treatment vessel 110 may have any of the features or operating conditions previously described in the present disclosure for the contaminant treatment vessel 110.

### EXAMPLES

Embodiments of the present disclosure will be further clarified by the following examples.

### Example 1: Treatment of Alkaline Wastewater with Hydrogen Peroxide

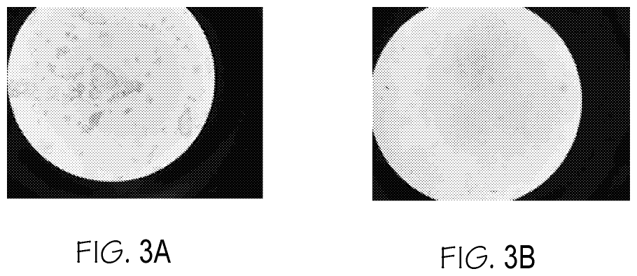

In Example 1, alkaline wastewater was treated with hydrogen peroxide to reduce oxidizable contaminants, such as sulfide, from the alkaline wastewater. In this example, 500 milliliters (mL) of the synthetic alkaline wastewater were prepared and purged with nitrogen to eliminate all dissolved oxygen. Na₂S·9H₂O was added so the alkaline wastewater initially contained sulfide at an amount of 12.2 milligrams per liter (mg/L) of alkaline wastewater. Inject H₂O₂ solution into above sample surface at 50 mg/l dose. One more sample was prepared but without the injection of H₂O₂ solution. Each of these two samples were then added to another two empty sample bottles containing ZnAc powders to precipitate remaining S²⁻. The resulting sample was filtered and the filter paper was examined under microscope to determine the presence of S²⁻ (ZnS). The results are shown in FIG. 3A and FIG. 3B. FIG. 3A shows the filter paper for the sample without H₂O₂ treatment, and FIG. 3B shows the results after H₂O₂ treatment. It can be seen the treatment with H₂O₂ reduced the amount of S²⁻ in the prepared alkaline wastewater sample.

As can be seen from FIG. 3A and FIG. 3B, treating an alkaline wastewater with hydrogen peroxide may reduce oxidizable contaminants, such as sulfides, from the alkaline wastewater. The dosage of hydrogen peroxide may be varied depending on the alkaline wastewater and the desired amount of reduction of the oxidizable contaminants.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for the treatment of oxidizable contaminants in wastewater, the method comprising:
supplying the wastewater to a contaminant treatment vessel;
supplying hydrogen peroxide to the contaminant treatment vessel, wherein: the hydrogen peroxide is supplied to the contaminant treatment vessel above a maximum wastewater fill line of the contaminant treatment vessel; and
contacting the wastewater in the contaminant treatment vessel with the hydrogen peroxide, wherein contacting the wastewater with the hydrogen peroxide reduces a concentration of oxidizable contaminants based on a concentration of oxidizable contaminants in a wastewater feed stream.

2. The method of claim 1, wherein the wastewater comprises a high alkaline wastewater.

3. The method of claim 1, wherein the wastewater comprises a pH of greater than 7.

4. The method of claim 1, wherein the wastewater comprises greater than 0.1 mg/l oxidizable contaminants.

5. The method of claim 1, wherein the wastewater is contacted with the hydrogen peroxide at a temperature less than 70 degrees Celsius.

6. The method of claim 1, wherein the wastewater is contacted with the hydrogen peroxide at a temperature of greater than 20 degrees Celsius to less than 50 degrees Celsius.

7. The method of claim 1, wherein the hydrogen peroxide is supplied to the contaminant treatment vessel at least half a meter above the maximum wastewater fill line of the contaminant treatment vessel.

8. The method of claim 1, wherein contacting the wastewater in the contaminant treatment vessel with the hydrogen peroxide reduces the concentration of oxidizable contaminants in the wastewater.

9. The method of claim 1, wherein the oxidizable contaminants comprise sulfides, nitrites, phosphites, or a combination of these.

10. A system for the treatment of oxidizable contaminants in wastewater, the system comprising:
a contaminant treatment vessel;
a hydrogen peroxide supply unit comprising a hydrogen peroxide transfer line in fluid communication with the contaminant treatment vessel, wherein:
the hydrogen peroxide transfer line comprises one or more hydrogen peroxide pumps, one or more ball valves, and one or more check valves;
the hydrogen peroxide transfer line is in fluid communication with the contaminant treatment vessel at a hydrogen peroxide injection point, wherein the hydrogen peroxide injection point is positioned above a maximum wastewater fill level of the contaminant treatment vessel such that an air gap exists between the wastewater in the contaminant treatment vessel and the hydrogen peroxide injection point;
a wastewater feed stream in fluid communication with the contaminant treatment vessel; and
a contaminant treatment vessel effluent stream in fluid communication with the contaminant treatment vessel, the contaminant treatment vessel effluent stream comprising less oxidizable contaminants regardless of an initial concentration of oxidizable contaminants in the wastewater feed stream.

11. The system of claim 10, wherein the contaminant treatment vessel is operable to oxidize the oxidizable contaminants in the wastewater feed stream.

12. The system of claim 10, wherein the one or more hydrogen peroxide pumps are air diaphragm pumps.

13. The system of claim 10, wherein the one or more ball valves are vented ball valves.

14. The system of claim 10, wherein the hydrogen peroxide supply unit comprises materials of construction that are pickled, passivated, or both.

15. The system of claim 10, wherein the oxidizable contaminants comprise sulfides, nitrite, phosphite, or a combination of these.
